(19) United States
(12) Patent Application Publication
(10) Pub. No.: US 2022/0280271 A1
(43) Pub. Date: Sep. 8, 2022

(54) Ridge Care

(71) Applicant: Jamie Sharp, Black Diamond, WA (US)

(72) Inventor: Jamie Sharp, Black Diamond, WA (US)

(21) Appl. No.: 17/193,844

(22) Filed: Mar. 5, 2021

(51) Int. Cl. A61C 13/25; A61C 13/07

(52) U.S. Cl. CPC A61C 13/25; A61C 13/0025; A61C 2201/002

(57) ABSTRACT

The disclosed denture and gum material will allow patients to function in chewing and speech with confidence. The Ridge Care will provide a more comfortable fitting denture with better suction. It will allow for a more natural feel, and better shock absorption when chewing as well as, looking more natural. The disclosure includes a palatal denture defining multiple lingual retention holes adjacent a patient's gums designed to enable a better suction of the denture against an inside lingual surface of the patient's mouth via a transfer of pressure there across. The disclosure additionally includes an impression formed hard material liner formed to a gum contour of the patient's gums and configured to sit against the palatal denture and the lower denture. The disclosure further includes a soft material liner disposed on the hard material liner, the soft material liner configured to sit against the patient's palatal gums and lower gums.

### BACKGROUND

Patients struggle all the time with their dentures, that the acrylic is too hard on their tender gums and ridge. The soft material that is being used now, does help, but then it doesn't last very long and peels out. Or patients can't afford implants or implant supported dentures, so they just suffer and constantly come in for adjustments. Right now the silicone materials that are available are for temporary relines and are not made to last. There have been no products available as original equipment or as an aftermarket to address this problem.

An apparatus to simplify relining dentures and effectively relieving the pain associated with wearing dentures. There have been no products available as original equipment or as an aftermarket to address this problem either.

There exists a need for a device such as Ridge Care, that is not being met by any known or disclosed device or system of present.

### SUMMARY OF THE INVENTION

Ridge Care is a hard/soft type of denture that patients can wear with more ease and comfort than traditional dentures. This invention also may be used to reline a patient's existing denture or to reline new dentures.

The disclosure includes a palatal denture defining multiple lingual retention holes adjacent a patient's gums designed to enable a better suction of the denture against an inside lingual surface of the patient's mouth via a transfer of pressure there across. The disclosure also includes a lower denture defining a gum line following a contour of the patient's lower gums. The disclosure additionally includes an impression formed hard material liner formed to a gum contour of the patient's gums and configured to sit against the palatal denture and the lower denture. The disclosure further includes a soft material liner disposed on the hard material liner, the soft material liner configured to sit against the patient's palatal gums and lower gums.

### BRIEF DESCRIPTION OF THE DRAWINGS

FIG. 1. This is a front elevational view of the Ridge Care on dentures in accordance with an embodiment of the present disclosure.

FIG. 2. This is a Palatal top elevational view of the Ridge Care on dentures in accordance with an embodiment of the present disclosure.

FIG. 3. This is a Palatal bottom elevational view of the Ridge Care on dentures in accordance with an embodiment of the present disclosure.

FIG. 4. This is the lower denture top elevational view of the Ridge Care on dentures in accordance with an embodiment of the present disclosure.

FIG. 5. This is the lower denture bottom elevational view of the Ridge Care on dentures in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

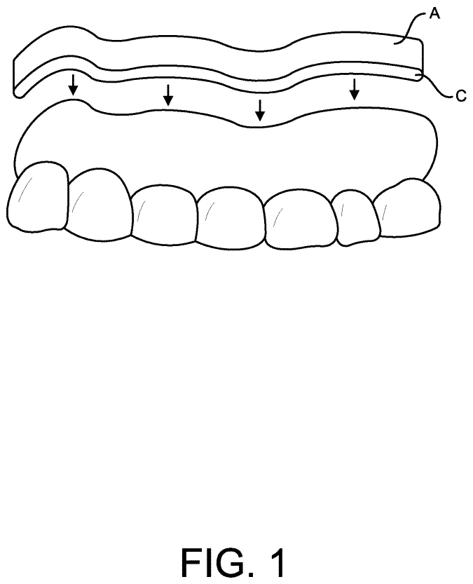

FIG. 1. This is a front elevational view of the Ridge Care on dentures showing: A. Soft silicone gum material lining, in accordance with an embodiment of the present disclosure. The depiction also includes the hard material liner C. The hard material liner may form the palatal denture and may also form a rigid portion of the lower denture.

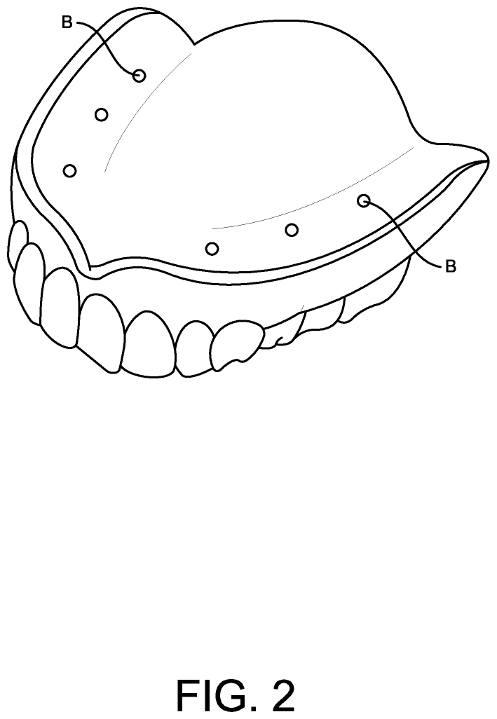

FIG. 2. This is a Palatal top elevational view of the Ridge Care on dentures showing: B. Lingual retention holes, in accordance with an embodiment of the present disclosure.

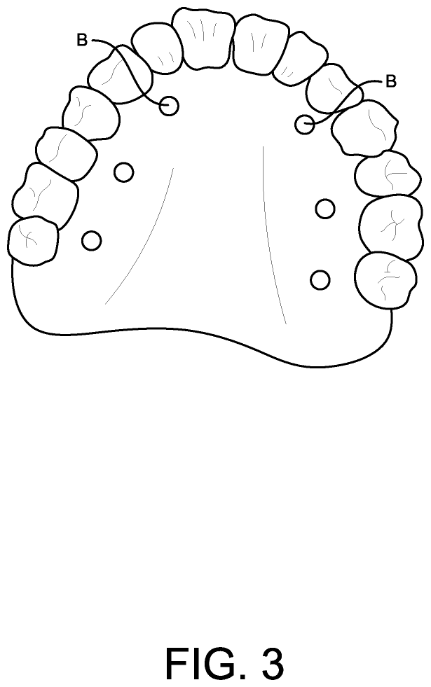

FIG. 3. This is a Palatal bottom elevational view of the Ridge Care on dentures showing: B. Lingual retention holes, in accordance with an embodiment of the present disclosure.

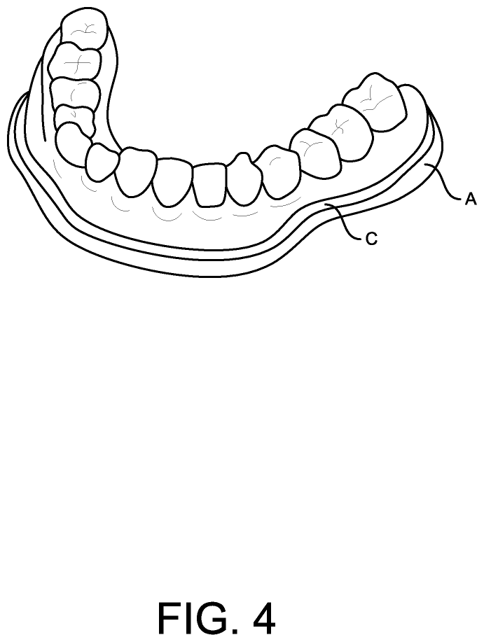

FIG. 4. This is the lower denture top elevational view of the Ridge Care on dentures showing: A. Soft silicone gum material lining, in accordance with an embodiment of the present disclosure. The hard material liner forms the palatal denture and also forms a portion of the lower denture.

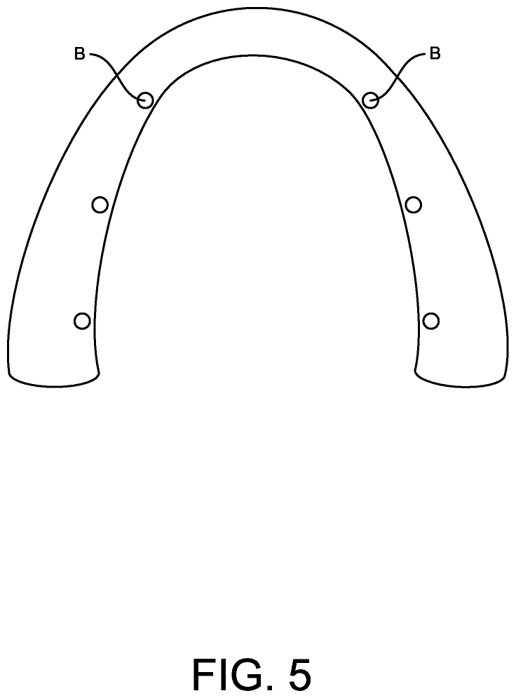

FIG. 5. This is the lower denture bottom elevational view of the Ridge Care on dentures showing: B. Lingual retention holes, in accordance with an embodiment of the present disclosure

The Ridge Care invention has a hard acrylic on the outside and a soft gum material on the inside, providing better comfort for the patient. This apparatus expands on the functionality of regular dentures. Once the denture is made, through the normal procedure, an inside of the denture is roughened up and an adhesive is placed thereon. The gum material is placed and processed just like a reline of acrylic to capture the patient's anatomy by taking an impression with the denture inside the patients mouth. The lab relines the inside with the soft silicone. A very thin layer, but same kind of consistency of acrylic used to seal the soft silicon and to bond it to the acrylic, so it won't peal out. A gloss is then placed as a seal over the boarders and either the palatal or lingual side of the denture. A dye also may be used on the silicone, so the shade matches for aesthetic looks.

The silicone used is similar to products being used for models in restoration cases such as implants. The gum like appearance and feel in the relined dentures is about 1-2 mm thick. With the impression taken with the acrylic denture it will capture patients exact gum details to provide the best fit and comfort. The idea of retention holes undisclosed in prior art, provides durability for patients for long lasting dentures to be virtually maintenance free.

This invention is uniquely designed with retention holes for more strength and durability than other products currently out on the market. With the use of retention holes, the material will be more secure inside the denture and won't peel out. Furthermore, this invention gives a better fit and comfort to the patient.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A denture device for an inside lingual surface and a gum line of a patient's mouth and comprising:
a denture defining a plurality of lingual retention holes there through and configured to enable a suction of the denture to the inside lingual surface of the patient's mouth via a transfer of a fluid pressure across the denture;
a hard material liner preformed to a contour of the denture and configured to sit against the denture; and
a soft material liner disposed between the hard material liner and the gum line of the patient's mouth.

2. The denture device of claim 1, further comprising a glossy seal applied to a plurality of borders of the denture device.

3. The denture device of claim 1, further comprising a gum colored dye applied to the soft material liner and to the hard material liner to give an aesthetic appearance there to.

4. The denture device of claim 1, wherein the plurality of lingual retention holes are circular.

5. The denture device of claim 1, wherein the plurality of lingual retention holes follow the contour line of the denture.

6. The denture device of claim 1, further comprising a palate portion of the denture device devoid of any of the plurality of lingual retention holes.

7. The denture device of claim 1, wherein a number of the plurality of lingual retention holes is six.

8. The denture device of claim 1, wherein a thickness of the hard material liner and the soft material liner is a nominal 2 millimeters.

9. The denture device of claim 1, wherein the hard material liner comprises acrylic.

10. The denture device of claim 1, wherein the soft material liner comprises silicon.

11. The denture device of claim 1, wherein a diameter of the plurality of lingual retention holes is a nominal 2 millimeters.

12. The denture device of claim 1, wherein the denture device comprises a gum line portion and a palatal portion.

13. The denture device of claim 1, wherein a number of the plurality of lingual retention holes on a first gum line side of the denture equal a number of the plurality of lingual retention holes on a second gum line side of the denture.

14. A denture system for an inside lingual surface and a palatal gum line and a lower gum line of a patient's mouth and comprising:
a palatal denture defining a plurality of lingual retention holes adjacent the patient's palatal gum line configured to enable a suction of the denture against the inside lingual surface of the patient's mouth via a transfer of a fluid pressure there across;
a lower denture following a contour of the patient's lower gum line;
an impression formed hard material liner formed to the palatal denture and the lower denture; and
a soft material liner disposed on the impression formed hard material liner, the soft material liner configured to sit between the patient's palatal gums and lower gums and the impression formed hard material.

15. The denture system of claim 14, wherein the palatal denture follows an inside roof contour of the patient's mouth.

16. The denture system of claim 14, further comprising a glossy seal applied to a plurality of borders of the denture device.

17. The denture system of claim 14, further comprising a gum colored dye applied to the soft material liner and to the impression formed hard material liner to give an aesthetic appearance there to.

18. The denture system of claim 14, further comprising the lower denture defining a plurality of gum line retention holes adjacent the patient's gum lines and configured to enable a suction of the denture against a gum surface of the patient's mouth via a transfer of pressure there across.

19. The denture system of claim 14, wherein a number of the plurality of lingual retention holes on a first gum line side of the denture equal a number of the plurality of lingual retention holes on a second gum line side of the denture.

20. The denture system of claim 14, further comprising a front teeth portion of the lower denture devoid of any of the plurality of gum line retention holes.
